(19) United States
(12) Patent Application Publication
(10) Pub. No.: US 2007/0022126 A1
(43) Pub. Date: Jan. 25, 2007

(54) Method and apparatus for updating an asset catalog

(75) Inventors: Wayne J. Wulfert, East Peoria, IL (US); Vern R. Smith, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/185,936

(22) Filed: Jul. 21, 2005

(51) Int. Cl. G06F 7/00

(52) U.S. Cl. 707/100

(57) ABSTRACT

A method and apparatus for updating a product catalog is disclosed which includes receiving a plurality of first assets into the catalog, each first asset having a hierarchy tag. At least a second asset having a hierarchy tag is added into the catalog. The plurality of first assets and the at least second asset are organized in a hierarchy. The catalog is accessible by a design tool.

### TECHNICAL FIELD

The present disclosure relates generally to a method and apparatus for updating a catalog, and more particularly, to a method and apparatus for updating an asset catalog.

### BACKGROUND

Computer applications, such as computer readable codes and/or data manipulation programs, can be designed and/or operated within a design environment that typically includes a computer and a graphically interfaced system design tool. System design tools typically include a software program that allows a user to design an application or manipulate data using an interrelated function-based approach within a graphical environment. Such system design tools usually include programmed structural relationships to organize underlying data stored in databases with interface objects displayed within a graphical user interface. Typically, such structural relationships include information to organize the interface objects within a taxonomy. As new data is introduced into the design environment, the programmed structural relationships within the system design tool must also be updated to avoid the underlying data from becoming asynchronous and/or to ensure the system design tool operates properly with the new data.

A method of updating underlying data within a system design tool is disclosed in U.S. Pat. No. 6,330,006 (“the '006 patent) issued to Goodisman. The '006 patent describes a method and apparatus for synchronizing interface objects of a graphic user interface with underlying data. The method and apparatus includes a system design tool aware of the structure of some of the underlying data and configured to determine the structure of underlying data with which it is not aware. Specifically, the design tool of the '006 patent enables a user to bind structural properties with previously unknown underlying data within the design tool to synchronize the information displayed in a graphic user interface and the information contained within a data source. The design tool is further configured to allow the user to manipulate the interface objects within the graphical user interface in accordance with the underlying application of the design environment.

Although the system design tool above may allow new data to be added to the system design tool, each introduction of new data requires a corresponding update to the design tool and potentially a significant degree of user expertise. Specifically, as new data is introduced into the design environment for which the system design tool is unaware of a corresponding underlying structural relationship, a user must bind the new data and a corresponding interface object within the system design tool. Because the structural relationship of the underlying data is retained in the design tool, a change in data requires the system design tool to be updated; either by binding by a user or within the system design tool program code by, for example, an update. Additionally, a user may need to be trained on how to bind data and interface objects and/or may need to be aware of the underlying data and how it should relate to the interface objects. New objects may be added frequently and, as such, changes in structural relationships may also frequently change. Frequent updates of the system design tool can be cumbersome, time consuming, and/or require special knowledge of the user.

The disclosed method and apparatus for updating an asset catalog is directed to overcoming one or more of the problems set forth above.

### SUMMARY OF THE INVENTION

In one aspect, the present disclosure is directed to a method for updating a product catalog. The method includes receiving a plurality of first assets into the catalog, each first asset having at least one hierarchy tag. The method further includes adding at least a second asset having a hierarchy tag into the catalog. The method still further includes organizing the plurality of first assets and the at least second asset in a hierarchy. The catalog is accessible by a design tool.

In another aspect, the present disclosure is directed to a method for updating an asset repository. The method includes organizing a plurality of first assets within an asset catalog in accordance with reusable asset specifications in a hierarchy. The method further includes adding a plurality of first assets to the repository from the catalog. The method still further includes organizing the plurality of first assets in the repository in accordance with reusable asset specifications at least partially based on the hierarchy within the catalog.

In a further aspect, the present disclosure is directed to a design environment including a system design tool, an asset catalog having a plurality of first assets wherein the plurality of first assets are organized in accordance with reusable asset specifications in a first hierarchy, and at least one asset repository having a plurality of second assets. The plurality of second assets is a subset of the plurality of first assets. The plurality of second assets is organized in a second hierarchy. The system design tool is configured to functionally relate at least two assets of the plurality of second assets.

### BRIEF DESCRIPTION OF THE DRAWINGS

FIG. 1 is a schematic illustration of an exemplary disclosed design environment; and

FIG. 2 is a schematic illustration of an exemplary asset of the system design tool of the design environment of FIG. 1;

FIG. 3A is an illustration of an exemplary first hierarchy of assets for an asset catalog and/or asset repository of the design tool of the design environment of FIG. 1; and

FIG. 3B is an illustration of an exemplary second hierarchy of assets for an asset catalog and/or asset repository of the design tool of the design environment of FIG. 1.

### DETAILED DESCRIPTION

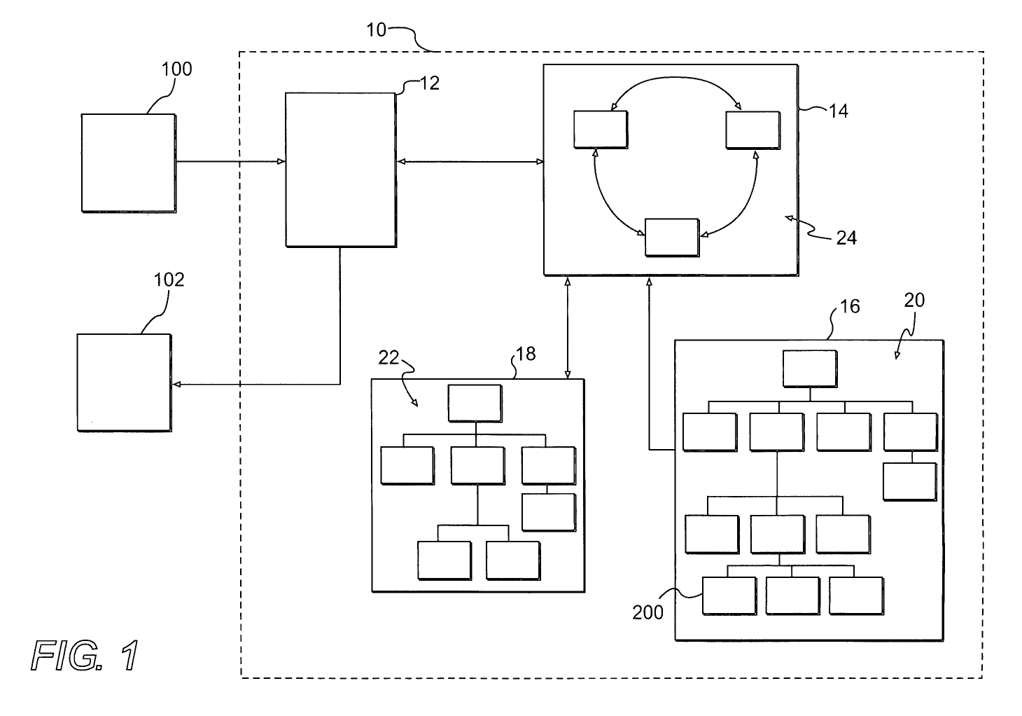

FIG. 1 illustrates an exemplary schematic of a design environment 10. Design environment 10 may include a computer 12, a system design tool 14, an asset catalog 16, and an asset repository 18. Computer 12 maybe configured to accept user inputs from a user 100, communicate with system design tool 14, and transfer generated software code to interact with a hardware component 102. System design tool 14 may be configured to receive user inputs from computer 12, functionally interconnect assets, generate software code, and output the generated software code to computer 12. Asset catalog 16 and asset repository 18 may be configured to be accessible by system design tool 14 to functionally select and transfer assets therebetween.

Computer 12 may include a general purpose computer configured to operate executable computer code. Computer 12 may include one or more input devices, such as, for example, a keyboard (not shown) or a mouse (not shown) to introduce user inputs into computer 12; one or more data manipulation devices, such as, for example, databases (not shown) or software programs (not shown) to transfer and/or alter user inputs; and one or more communication devices, such as, for example, a modem (not shown) or a network link (not shown) to communicate inputs and/or outputs with system design tool 14. It is contemplated that computer 12 may further include additional and/or different components, such as, for example, a memory (not shown), a communications hub (not shown), a data storage (not shown), a printer (not shown), an audio-video device (not shown), removable data storage devices (not shown), or other components known in the art. It is also contemplated that computer 12 may communicate with system design tool 14 via, for example, a local area network (“LAN”), a hardwired connection, and/or the Internet. It is further contemplated that computer 12 may include a plurality of computers each configured to communicate with system design tool 14.

System design tool 14 may be configured to communicate with computer 12, asset catalog 16, and asset repository 18 to functionally transfer and/or interconnect assets within a graphical user interface (“GUI”) (not shown). Specifically, system design tool 14 may be configured to add a second plurality of assets 22 to asset repository 18 from a first plurality of assets 20 in asset catalog 16 and to select a subset of assets 24 from asset repository 18 and functionally interconnect subset of assets 24. System design tool 14 may further be configured to generate software code at least partially based on the functionally interconnected subset of assets 24 and output the software code to computer 12. It is contemplated that system design tool 14 may be configured as a click and drag interface, where user inputs select icons within the GUI and selectively move the icons to interconnect assets; a read-write interface, where user inputs write commands within the GUI to interconnect assets; a drop down table interface, where user inputs select assets from organized tables within the GUI to functionally interconnect assets; or other graphical interfaces known in the art. It is contemplated that the generated software code may be a computer readable code and may be written in a known software format, such as, for example, a software flash file. It is also contemplated that the illustration of system design tool 14 interconnecting subset of assets 24 is for clarification purposes only and system design tool 14 may, within system limits, functionally interconnect any number of assets. It is further contemplated that system design tool 14 may be stored within the memory of computer 12 and/or within the memory of each of a plurality of computers 12 and may be configured to communicate with asset catalog 16 and asset repository 18 over the Internet.

Asset catalog 16 may include first plurality of assets 20 and may be configured to store and/or link to the location of first plurality of assets 20 and interact with system design tool 14. Asset catalog 16 may embody a database or other data manipulation table known in the art. Asset catalog 16 may store and/or organize first plurality of assets 20 in a hierarchy in accordance with reusable asset specifications (“RAS”). It is contemplated that first plurality of assets 20 stored and/or linked within asset catalog 16 may include, within practical limits, any number of assets. It is also contemplated that asset catalog 16 may directly be accessible by computer 12 via the Internet, such as, for example, without computer 12 communicating with system design tool 14.

Asset repository 18 may include second plurality of assets 22 and may be configured to store and/or link to the location of second plurality of assets 22 and interact with system design tool 14. Asset repository 18 may embody a database or other data manipulation table known in the art. Second plurality of assets 22 may, for example, form a subset of first plurality of assets 20, may embody assets designed by user 100, and/or may include assets from any known asset collection having one or more assets therein. Asset repository 18 may store and/or organize second plurality of assets 22 in a hierarchy in accordance with RAS. It is contemplated that second plurality of assets 22 stored and/or linked within asset repository 18 may include, within practical limits, any number of assets. It is also contemplated that asset repository 18 may include a plurality of asset repositories 18′ each configured to store a plurality of assets. It is also contemplated that asset repository 18 may be stored within the memory of computer 12, within a memory of a computer server (not shown), and/or may be accessible by system design tool 14 via the Internet. It is further contemplated that asset repository 18 may embody a single asset repository and may be configured to be accessible by a plurality of computers 12 and/or a plurality of system design tools 14.

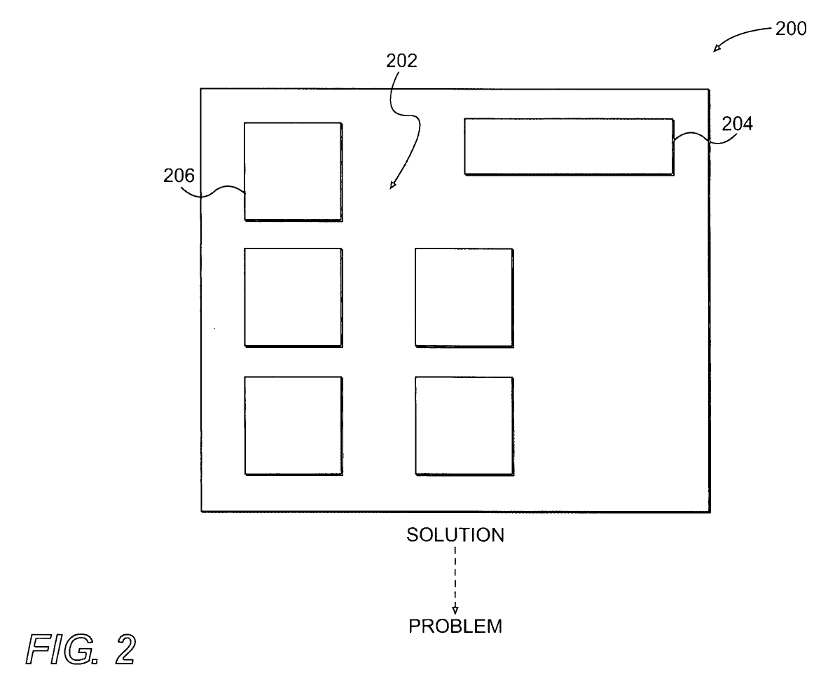

FIG. 2 illustrates an exemplary asset 200 to which reference is now made for clarification purposes only. It is understood that the description of asset 200 may be applicable to first plurality of assets 20, second plurality of assets 22, and/or subset of assets 24. Asset 200 may be configured to provide a solution to a problem for a given context and may include artifacts 202 and at least one manifest file 204. Artifacts 202 may include one or a plurality of artifacts. Additionally, asset 200 may include a variability point (not shown), rules for usage (not shown), and/or instructions (not shown) describing how the asset should be used. Specifically, artifacts 202 may be workproducts from a software development lifecycle, such as, for example, software code files, scripts, requirements, documents, and/or other workproducts known in the art. It is contemplated that artifacts 202 may also include an identifier to direct a user and/or system design tool 14 to a workproduct stored remotely from design environment 10. It is also contemplated that artifacts 202 may be stored in data fields within asset 200 and may include descriptors, such as, for example, name, function, benefit, requirements, content owner, use, compatibility, performance, brief description, and/or other descriptors known in the art and used to describe asset 200. It is also contemplated that the workproducts may include any known file format, such as, for example, .java, .doc, .xls, .gif, .txt, and/or other known file formats. It is further contemplated that asset 200 may include and/or embody a software code sub-routine configured to be interconnected with other assets that may embody software code sub-routines to form a software code program designed to operate a particular algorithm.

Asset 200 may specify required artifacts 202 and declare specific use contexts for asset 200. Assets, in general, may be described using at least three dimensions: granularity, variability, and articulation. Granularity may describe how many particular problems and/or solutions a particular asset addresses. For example, simple assets may offer a single solution or address a single well-defined problem. As granularity increases, an asset may address multiple problems. Variability may describe the degree to which a user may alter the asset. For example, invariable assets may be fixed and unalterable. As variability increases, a user may be able to edit and alter an asset to meet specific user demands. Articulation may describe the degree of completeness of the artifacts 202 in providing a solution. For example, non-complex artifacts 202 may specify a solution, but may not provide the solution. As articulation increases, an artifact 202 may specify and implement a solution in connection with other supporting workproducts.

Asset 200 may include a software component. Asset 200 may be configured as a sub-routine to provide a software solution to a software problem. Specifically, asset 200 may include artifacts 202 configured to perform a sub-routine of a computer executable routine. Asset 200 may be configured to be interconnected with other software and/or hardware assets and may be configured to accept inputs, perform an algorithm, and deliver outputs. For example, asset 200 may accept inputs from another software and/or hardware asset, perform an algorithm with the accepted inputs to manipulate, change, and/or modify the accepted inputs, and deliver outputs to yet another software and/or a hardware asset. Artifacts 202 may include a description of the problem the sub-routine solves, the sub-routine, the required inputs, the delivered outputs, and/or other workproducts.

Asset 200 may further include a hierarchy tag 206 configured as one of artifacts 202. Hierarchy tags 206 may include a ranking indicator configured to designate the associated asset 200 within a hierarchy relative to other assets. For example, hierarchy tag 206 may indicate asset 200 as a simple asset, e.g., an asset having a low granularity, and accordingly may be configured to provide a ranking indicator to organize asset 200 below other assets having higher granularity. Similarly, hierarchy tag 206 may additionally and/or alternatively indicate the asset 200 with a particular solution and/or particular problem. Accordingly, hierarchy tag 206 may be configured to provide a ranking indicator to organize asset 200 relative to other assets according to types of solutions and/or problems. For example, an asset may provide a solution to control a particular hardware component and may be organized with assets providing similar solutions and may not be organized with assets providing dissimilar solutions. It is contemplated that hierarchy tag 206 may include any ranking indicator to organize asset 200 relative to other assets. It is also contemplated that asset 200 may include a plurality of hierarchy tags.

Manifest file 204 may reference artifacts 202 and may be configured as an eXtensible Markup Language (“XML”) document. Manifest file 204 may be configured to associate artifacts 202 with one another and/or asset 200 with other assets. It is contemplated that asset 200, including one or all of artifacts 202 and/or manifest file 204, may be packaged into a single archive file, such as, for example, using a Zip compression algorithm. Such a packaging may make distribution of asset 200 easier because of decreased file size and/or pre-management of the complexity of the asset.

### INDUSTRIAL APPLICABILITY

The disclosed method and apparatus for updating asset catalog 16 may be applicable to any design environment. The disclosed method and apparatus may provide less cumbersome and less time consuming updating of products within an asset catalog and may enable more frequent updates thereof. The operation of design environment 10 and, more particularly, system design tool 14 is explained below.

Design environment 10 may be configured to generate a software code to control a hardware component 102. The generated software code may include an embedded code that is transferred from computer 12 to hardware component 102 and may be configured to operate, monitor, and/or manipulate hardware component 102. For example, the generated software code may embody a sub-routine to monitor outputs from a temperature sensor and output a true-false value to a light emitting diode (“LED”) indicator. It is contemplated that the generated software may include a code necessary to operate hardware components, such as, for example, sensor monitoring, hydraulic valve control, engine control, work implement control, and/or any other hardware control. It is also contemplated that the generated software code may include a code to operate, control, and/or interact with other software codes. It is further contemplated that the generated software code may be transferred to hardware component 102, via flash transfer protocol as is known in the art, directly from computer 12 and/or indirectly from computer 12 via secondary computer devices, such as, for example, other computers, computer servers, and/or other known computer devices.

The following operation of system design tool 14 is illustrated with reference to the addition of new assets to asset catalog 16 and the updating of asset catalog 16 and the corresponding updating of asset repository 18. It is noted that the explanation below is for clarification purposes only, and the method and apparatus may be applicable for any change in assets within an asset catalog.

First plurality of assets 20 may be uploaded into asset catalog 16 in a manner known in the art, such as, for example, data entry. First plurality of assets 20 may be uploaded by a system administrator upon initialization of asset catalog 16 and/or periodically. First plurality of assets 20 may be organized within asset catalog 16 based upon their respective hierarchy tags and may be configured into a hierarchy tree. As new assets having a hierarchy tag are subsequently added into asset catalog 16, the hierarchy tree therein may be automatically updated via an organizing algorithm and/or by an administrator during uploading. It is contemplated that first plurality of assets 20 may be organized in a hierarchy in a manner known in the art, such as, for example, database ranking.

System design tool 14 may access first plurality of assets 20 in response to user inputs communicated from computer 12. Specifically, a user may browse through first plurality of assets 20 and functionally select desired assets therefrom to be moved into asset repository 18. For example, user 100 may be interested in some of first plurality of assets 20 and may, via system design tool 14 and, in particular, the GUI, functionally select that some of first plurality of assets 20 be transferred into asset repository 18 and/or functionally indicate that some of first plurality of assets 20 may in the future be transferred into asset repository 18. As a result, user 100 may functionally establish second plurality of assets 22 within asset repository 18.

System design tool 14 may access assets 20 in asset catalog 16 and/or assets 22 in asset repository 18 in response to user inputs communicated from computer 12 to establish subset of assets 24. System design tool 14 may display subset of assets 24 in the GUI, user 100 may select one or more of subset of assets 24, and user 100 may direct system design tool 14 to functionally interconnect the selected assets of subset of assets 24.

For example, user 100 may access system design tool 14 via computer 12 in order to generate a software code to operate a warning LED based on a temperature sensor. User 100 may access, via the GUI of system design tool 14, a list or table of available assets 200 configured to provide solutions to the problem of operating an LED. Specifically, user 100 may browse through second plurality of assets 22 via a hierarchy to select desired assets. For example, user 100 may browse through assets 22 to find and select several assets configured to output a constant true value signal based upon a first received input, monitor a sensor output and convert the output into a communication signal, and/or perform other sub-routines available and or desired from second plurality of assets 22.

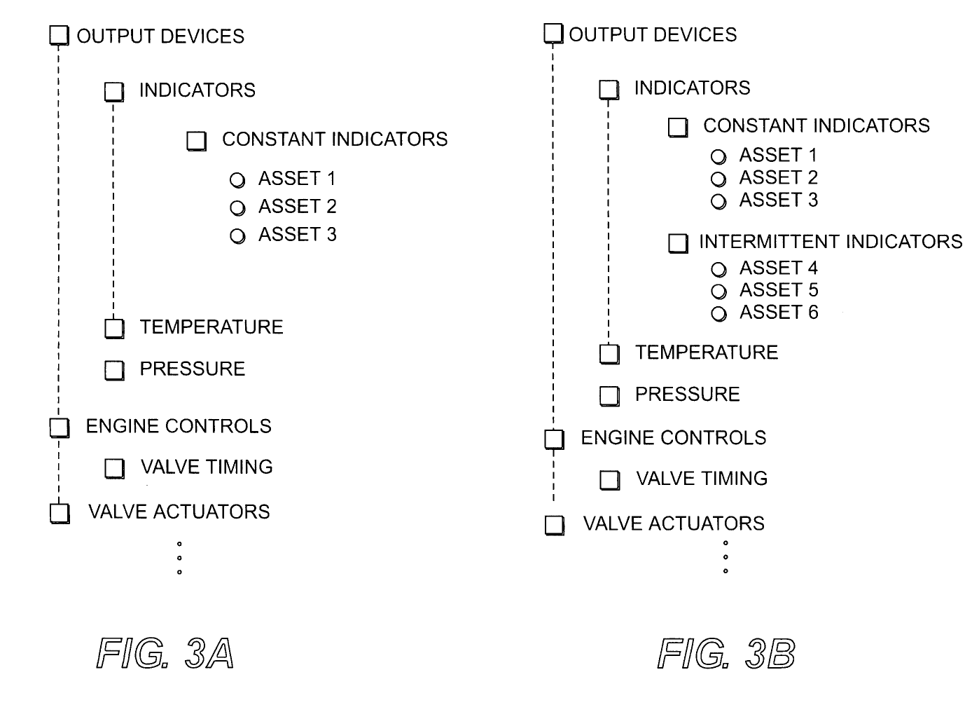

Referring to FIG. 3A, user 100 may, initially open a hierarchy class labeled “Output Devices” because LEDs are known by the user to be labeled an output device. Subsequently, user 100 may open a hierarchy class labeled “Indicators” because LEDs are known by the user to be sub-located within the output device hierarchy. Additionally, user 100 may open a hierarchy class labeled “Constant Indicators” and select an asset labeled and described to operate to output a constant true value signal based upon an input. Finally, user 100 may select other assets as desired or needed. It is contemplated that the hierarchy classes and labels discussed above are for clarification purposes only and any labels, number of classes, or degrees of refinement may be used within a hierarchy.

User 100 may use a similar selection process to select other assets, such as, a temperature sensor asset and/or other assets desired and/or necessary to operate the LED. It is contemplated that system design tool 14 may display within the GUI other necessary and/or potentially desirable assets from within second plurality of assets 22 and/or first plurality of assets 20. For example, if user 100 selects a constant true value output asset, system design tool 14 may be configured to automatically display a plurality of other assets compatible with, necessary for, and/or desirable to be interconnected with a constant true value output asset.

As assets 200 are designed and/or modified, assets 20 in asset catalog 16 may need to be modified, removed, and/or new assets may need to be added. For example, if an intermittent indicator sub-routine has been developed subsequent to the development of a constant indicator sub-routine, a new asset for the intermittent indicator sub-routine may need to be added into asset catalog 16. As a result, the hierarchy of assets 20 may change. Referring to FIG. 3B, an additional hierarchy class and/or classes may be added within the above referenced “Output Devices” hierarchy in part based on the respective hierarchy tags 206 of the newly added assets 200. For example, a hierarchy class labeled “Intermittent Indicators” may need to be added within the “Output Devices” hierarchy. As such, the new hierarchy may be organized within asset catalog 16 automatically and/or by an administrator when the newly developed intermittent indicator asset is added into the plurality of assets 20 within asset catalog 16. As a result, user 100 may be able to open a hierarchy class labeled “Intermittent Indicators” and select an asset therein without the system design tool 14 itself being updated.

For another example, if constant indicator assets are discontinued, such assets may need to be removed from asset catalog 16. As a result, the hierarchy of assets 20 may change. Specifically, the hierarchy class labeled “Constant Indicators” may be removed from within the above referenced “Output Devices” hierarchy. Similar to adding a new hierarchy class (discussed above), the new hierarchy may be organized within asset catalog 16 automatically and/or by an administrator when the discontinued constant indicator assets are removed from the plurality of assets 20 within asset catalog 16. As a result, user 100 may be unable to open the hierarchy class labeled “Constant Indicators” and select an asset therein even though the system design tool 14 itself has not been updated. It is contemplated that discontinued assets removed from asset catalog 16 may remain within asset repository 18 if such an asset was transferred to asset repository 18 prior to the asset being discontinued.

Similarly, because asset 200 may include hierarchy tag 206, if asset 200 is transferred into asset repository 18, a hierarchy therein will automatically be organized at least partially based on hierarchy tag 206 and the hierarchy tag of the other assets within asset repository 18. Specifically, the hierarchy within asset repository 18 operates and functions similar to asset catalog 16 as described above.

Because assets are organized in a hierarchy in asset catalog 16, as new assets are developed and previous assets are discontinued and/or modified, system design tool 14 may display the new hierarchy in the GUI to user 100 without the system design tool 14 being updated and/or reprogrammed. As a result, updating assets for use within a system design tool may be simpler, less time consuming, and/or be performed more frequently.

It will be apparent to those skilled in the art that various modifications and variations can be made to the disclosed method and apparatus of updating an asset catalog. Other embodiments will be apparent to those skilled in the art from consideration of the specification and practice of the disclosed method and apparatus of updating an asset catalog. It is intended that the specification and examples be considered as exemplary only, with a true scope being indicated by the following claims and their equivalents.

What is claimed is:

1. A method for updating an asset catalog comprising:
receiving a plurality of first assets into the catalog, each first asset having at least one hierarchy tag;
adding at least one second asset having at least one hierarchy tag into the catalog; and
organizing the plurality of first assets and the at least one second asset in a hierarchy at least partially based on the hierarchy tags, the catalog being accessible by a design tool.

2. The method of claim 1, wherein organizing the plurality of first assets and the at least second asset in a hierarchy is in accordance with reusable asset specifications.

3. The method of claim 1, further including:
removing at least one asset from the plurality of first assets; and
organizing the remaining plurality of first assets in a hierarchy.

4. The method of claim 1, wherein adding at least a second asset includes adding a plurality of second assets each having at least one hierarchy tag.

5. The method of claim 4, further including organizing the plurality of first assets and the plurality of second assets in a hierarchy.

6. The method of claim 1, wherein each of the plurality of first assets includes a plurality of artifacts, each artifact configured as workproducts and a manifest file configured to associate the plurality of artifacts, the at least one hierarchy tag being one of the plurality of artifacts.

7. The method of claim 6, wherein the at least one hierarchy tag stores asset ranking information at least partially based on the other of the plurality of assets.

8. The method of claim 5, wherein the plurality of first assets and the at least one second asset are configured to be transferable to an asset repository by a design tool.

9. A method for updating an asset repository, comprising:
organizing a plurality of first assets within an asset catalog in accordance with reusable asset specifications in a hierarchy;
adding a plurality of second assets to the repository from the catalog, the plurality of second assets being a subset of the plurality of first assets; and
organizing the plurality of second assets in accordance with reusable asset specifications at least partially based on the hierarchy of the plurality of first assets.

10. The method of claim 9, wherein the catalog and the repository are accessible by a design tool, and the method further includes using the design tool to add the plurality of second assets to the repository from the catalog.

11. The method of claim 9, further including:
adding a plurality of third assets to the catalog; and
organizing the pluralities of first and third assets within the catalog in a hierarchy.

12. The method of claim 9, further including:
subsequently adding at least another asset to the repository; and
organizing the plurality of second assets and the another asset in a hierarchy.

13. The method of claim 9, wherein:
each of the assets of the pluralities of first assets and the plurality of second assets includes a plurality of artifacts configured as workproducts about the asset; and
at least one of the plurality of artifacts include a hierarchy tag.

14. The method of claim 9, wherein the plurality of first assets each include at least one hierarchy tag and the method further includes:
transferring at least one asset having at least one hierarchy tag from the catalog into the repository.

15. A design environment, comprising:
a system design tool;
an asset catalog having a plurality of first assets, the plurality of first assets being organized in accordance with reusable asset specifications in a first hierarchy; and
at least one asset repository having a plurality of second assets;
the plurality of second assets being a subset of the plurality of first assets;
the plurality of second assets being organized in a second hierarchy; and
the system design tool being configured to functionally relate at least two assets of the plurality of second assets.

16. The design environment of claim 15, wherein each of the plurality of first assets include of a plurality of artifacts configured as workproducts about the asset, and wherein at least one of the artifacts includes a hierarchy tag.

17. The design environment of claim 15, wherein each of the plurality of second assets include of a plurality of artifacts configured as workproducts about the asset and wherein at least one of the artifacts includes a hierarchy tag.

18. The design environment of claim 15, wherein the second hierarchy is at least partially based on the first hierarchy.

19. The design environment of claim 15, wherein the catalog further includes at least one third asset, and the plurality of first assets and the at least one third asset are organized in a third hierarchy, the third hierarchy being different than the first hierarchy.

20. The design environment of claim 15, further including:
a computer configured to communicate with the system design tool;
the system design tool being configured to generate a computer executable code at least partially based on the functional relation of the at least two assets; and
the computer being further configured to transfer the generated computer executable code to a hardware component.
